(19) United States
(12) Patent Application Publication
(10) Pub. No.: US 2014/0292611 A1
(43) Pub. Date: Oct. 2, 2014

(54) ANTENNA APPARATUS

(71) Applicant: Murata Manufacturing Co., Ltd., Nagaokakyo-shi (JP)

(72) Inventors: Hiroyuki KUBO, Shanghai (CN); Hiromitsu ITO, Nagaokakyo-shi (JP)

(73) Assignee: MURATA MANUFACTURING CO., LTD., Nagaokakyo-shi (JP)

(21) Appl. No.: 14/228,359

(22) Filed: Mar. 28, 2014

(30) Foreign Application Priority Data
Mar. 29, 2013 (CN) 201310109398.8

(51) Int. Cl. G06K 7/10; G06K 19/077; H01Q 7/00

(52) U.S. Cl. CPC G06K 7/10336; H01Q 7/00; G06K 19/07783
USPC 343/867

(57) ABSTRACT

An antenna apparatus includes an antenna substrate, a coil antenna including a conductive pattern located on the antenna substrate, a feeding coil magnetically coupled with the coil antenna, and a transceiver circuit electrically connected with the feeding coil. The feeding coil is disposed on the same substrate as the coil antenna, and is defined by a conductive pattern, which is not electrically connected with the coil antenna. Two terminals of the feeding coil are electrically connected with the transceiver circuit.

### BACKGROUND OF THE INVENTION

1. Field of the Invention

The present invention relates to an antenna apparatus, and particularly, relates to an antenna apparatus preferably for use in a RFID tag or a reader-writer of HF (High Frequency) frequency band.

2. Description of the Related Art

RFID (Radio Frequency Identification) systems have been used as payment systems or article management systems. In an RFID system, wireless communication can be conducted between the reader-writer and the RFID tag in a non-contact manner, and high frequency signals are received and transmitted between those devices. The reader-writer and the RFID tag include IC chips used in RFID for processing high frequency signals and antennas for receiving and transmitting high frequency signals, respectively.

For example, in a RFID system using an HF frequency band of 13.56 MHz, a coil antenna is used as an antenna. The coil antenna at the reader-writer side and the coil antenna at the RFID tag side are coupled via induced magnetic field.

For example, in Japanese Patent No. 4325621, a feeding coil to be connected with a transceiver circuit which is used by the RFID tag can be provided on a control substrate. A structure for magnetically coupling the feeding coil with the coil antenna disposed on the antenna substrate is disclosed. Thus, the electrical connection between the transceiver circuit on the control substrate and the coil antenna can be implemented without using communication cables. In addition, magnetic body sheet material is disposed between the antenna substrate and the control substrate.

However, in Japanese Patent No. 4325621, the control substrate having a feeding coil disposed thereon and the antenna substrate having a coil antenna disposed thereon are disposed on different substrates, such that the thickness thereof is large, and it is difficult to achieve miniaturization and thinning. Furthermore, magnetic body sheet material is disposed between the coil antenna and the feeding coil, and thus, there is a limitation for the sufficient magnetic coupling obtained between the coil antenna and the feeding coil, which may affect the performance of the antenna. Thus, due to the growing popularity of RFID system for various applications, the miniaturization and thinning of the antenna apparatus, and the improvement of the antenna performance is desired.

### SUMMARY OF THE INVENTION

Accordingly, preferred embodiments of the present invention provide an antenna apparatus which is miniaturized and thinned, and achieves excellent antenna performance.

An antenna apparatus according to a preferred embodiment of the present invention includes a feeding coil coupled electromagnetically with an IC chip and disposed on a same substrate as an antenna substrate including a coil antenna disposed thereon.

An antenna apparatus according to a preferred embodiment of the present invention includes an antenna substrate, a coil antenna including a conductive pattern disposed on the antenna substrate, a feeding coil magnetically coupled with the coil antenna, and a transceiver circuit electrically connected with the feeding coil, the feeding coil is disposed on the same substrate as the coil antenna, and is defined by a conductive pattern which is not electrically connected with the coil antenna, and two terminals of the feeding coil are electrically connected with the transceiver circuit.

With the structure according to the preferred embodiment described above, the coil antenna and the feeding coil are disposed on the same substrate so that the apparatus is significantly thinner, and the conductive pattern of the coil antenna and the conductive pattern of the feeding coil are adjacent to each other. As a result, sufficient magnetic coupling is obtained between the coils, and the performance of the antenna is significantly improved.

Preferably the feeding coil is located on a more outer peripheral side than a position where the coil antenna is located.

Thus, the conductive pattern defining the feeding coil is located at the outer peripheral side of the conductive pattern of the coil antenna, so the degree of freedom for designing the connection structure connecting the feeding coil and the transceiver circuit is greatly enhanced.

The coil antenna is preferably provided on a main surface of the antenna substrate such that a capacitance is generated between the adjacent conductive patterns.

Thus, by adjusting a distance between the adjacent antenna conductive patterns, a capacitance is obtained, and therefore, an additional capacitor(s) is not required, and the structure is further simplified and miniaturized.

The coil antenna preferably is provided on two main surfaces of the antenna substrate such that a capacitance is generated between the conductive patterns overlapped via the antenna substrate along the thickness direction.

Thus, a capacitance is obtained by utilizing an overlapping area between the conductive patterns of two main surfaces disposed on the antenna substrate. As a result, an additional capacitor(s) is not required, and the structure is further simplified and miniaturized. Because the capacitor of the coil antenna is obtained by utilizing the overlapping area of the conductive patterns located on two main surfaces of the antenna substrate, the capacitance is obtained more easily, and electrode loss is significantly decreased or prevented. As a result, performance of the antenna is further improved.

The coil antenna and the feeding coil are preferably provided on the same plane of the antenna substrate, such that the coil antenna and the feeding coil are located on a single surface of the antenna substrate, which makes the design even easier.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a top view of an antenna apparatus according to Preferred Embodiment 1 of the present invention, and FIG. 1B is a schematic view of the amplified dash line portion of FIG. 1A, showing the relationship between the electrostatic capacitances of the coil antenna and the feeding coil.

FIG. 2A is a top view of a portion of an antenna apparatus according to Preferred Embodiment 2 of the present invention, FIG. 2B is a back view of a portion of the antenna apparatus 10 of Preferred Embodiment 2, and FIG. 2C is a cross-sectional view of the structure of FIG. 2A.

FIG. 3 is an equivalent circuit view of Preferred Embodiment 2 according to the present invention.

### DETAILED DESCRIPTION OF THE PREFERRED EMBODIMENTS

The preferred embodiments of the present invention will be described in detail with reference to the drawings.

### Preferred Embodiment 1

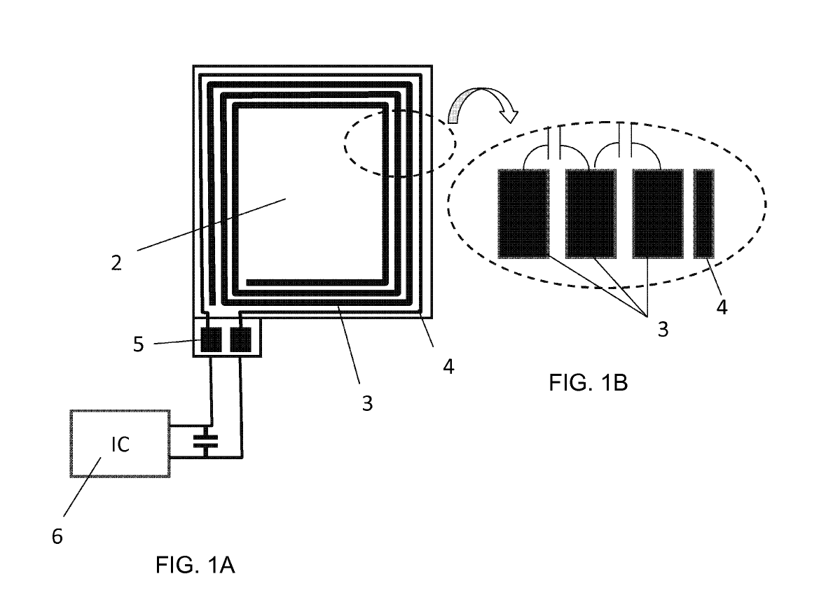

FIG. 1A is a top view of the antenna apparatus 1 according to Preferred Embodiment 1 of the present invention, and FIG. 1B is a schematic view of the amplified dash line portion of FIG. 1A, showing the relationship between the electrostatic capacitances of the coil antenna and the feeding coil. The antenna apparatus 1 according to Preferred Embodiment 1 of the present invention preferably includes an antenna substrate 2, a coil antenna 3 including a conductive pattern located on the antenna substrate 2, a feeding coil 4 magnetically coupled with the coil antenna 3, and a transceiver circuit 6 electrically connected with the feeding coil 4.

The antenna substrate 2 preferably is a PET substrate, having a rectangular or substantially rectangular planar shape, for example. The antenna substrate 2 is not limited to this; instead, for example, flexible substrates, and the like, can also be used as the antenna substrate 2.

The coil antenna 3 is provided on the antenna substrate 2. The coil antenna 3 preferably includes a planar shaped coil, which is preferably defined by a ring-shaped conductive pattern. The conductive pattern is preferably made of thin metal materials, such as copper foil or aluminum foil, and the like, for example. The coil antenna 3 preferably includes more than two turns, and for example, indicated in the dash line area of FIG. 1B, such that an inductance of the conductive pattern, or a capacitance, such as the capacitance caused by the capacitor between the lines of the conductive pattern, is taken into account, to design a line width and a width between the lines of the conductive pattern, so that the oscillation is generated near a signal frequency used for communication.

On the antenna substrate 2, a planar shaped feeding coil 4 is preferably provided on a plane which is the same as that on which the coil antenna 3 is provided, and the feeding coil 4 is preferably defined by the conductive pattern which is not connected with the conductive pattern of coil antenna 3. The conductive pattern of the feeding coil 4 preferably includes the thin metal materials, such as the copper foil, or aluminum foil, and the like, for example . The feeding coil 4 is shown within the dash line area of FIG. 1B as magnetically coupled with the adjacent coil antenna 3, and the strength of the magnetic coupling is easily adjusted by adjusting the distance between the feeding coil 4 and coil antenna 3.

With such a structure, the coil antenna 3 and the feeding coil 4 are disposed on the same substrate, so as to facilitate thinning of the apparatus, and since the coil antenna 3 and the feeding coil 4 are adjacent to each other, sufficient magnetic coupling is achieved between the coils, and the performance of the antenna is significantly improved. Furthermore, the capacitance is easily adjusted by adjusting the distance between the lines of the feeding coil 4 and the loop antenna 3.

Furthermore, electrode pads 5 are preferably provided at two terminals of the feeding coil 4, and the electrical connection to the transceiver circuit 6 is implemented via the electrode pads 5. Furthermore, although the capacitor to adjust capacitance may be preferably disposed between the transceiver circuit 6 and the electrode pads 5, the capacitor can also be omitted or not provided. For example, an IC chip, and the like, used by an RFID can be disposed in the transceiver circuit 6.

For example, in the present preferred embodiment, it is preferred to design the feeding coil 4 as a coil including one turn, and to locate the feeding coil 4 at a more outer peripheral side than the coil antenna 3. Previously, since the coil antenna 3 including more than two turns is directly electrically connected with the transceiver circuit 5, one terminal outputted from the coil antenna 3 must avoid the loop of the coil antenna 3, and thus the design of the conductive pattern of the coil antenna 3 is rather complicated. However, by directly connecting the feeding coil 4 and transceiver circuit 6, the feeding coil 4 is disposed at the outer peripheral side of the coil antenna 3, and the loop coil is designed as a coil including one turn, such that two terminals of the feeding coil 4 are outputted directly from the same plane, and the connection to the transceiver circuit 6 is designed more easily.

With such a structure, the coil antenna and the feeding coil are disposed on the same substrate, and therefore the apparatus is much thinner, and because the conductive pattern of the coil antenna and the conductive pattern of the feeding coil are adjacent to each other, sufficient magnetic coupling is obtained between the coils, and the performance of the antenna is significantly improved. Furthermore, the capacitance is easily adjusted by adjusting the distance between the lines of the feeding coil pattern and the coil antenna pattern.

### Preferred Embodiment 2

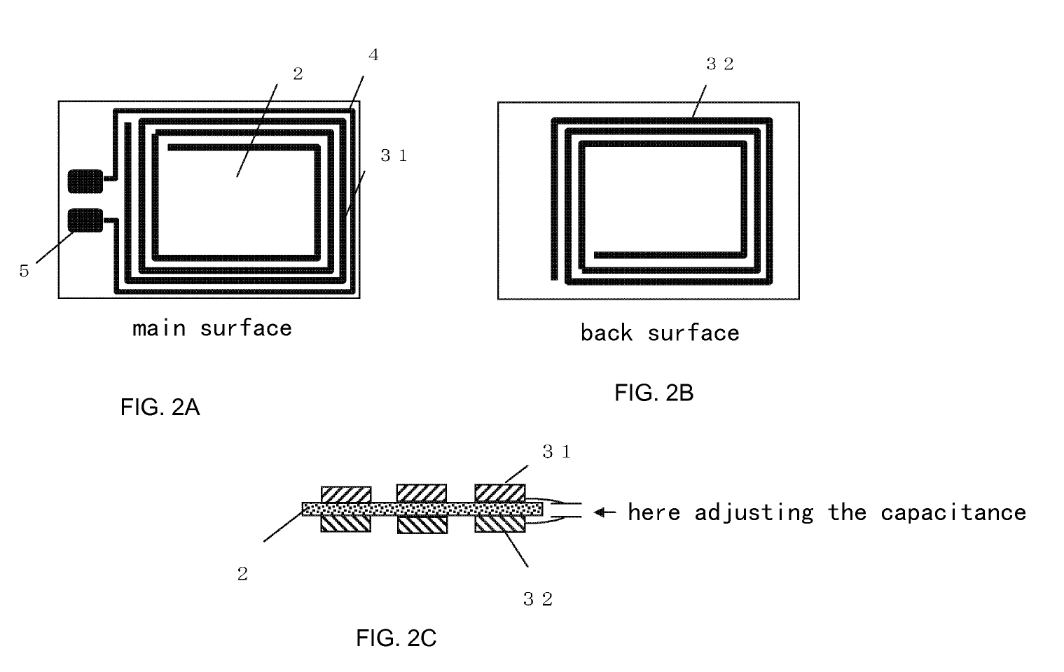

FIG. 2A is a top view of a portion of an antenna apparatus 10 according to Preferred Embodiment 2 of the present invention, FIG. 2B is a back view of a portion of the antenna apparatus 10 according to Preferred Embodiment 2, and a structure up to the electrode pad 5 connected with the transceiver circuit 6 is illustrated. Because the structure and the connection of the transceiver circuit 6 are preferably the same or substantially the same as those in Preferred Embodiment 1, they are omitted in the drawings relating to Preferred Embodiment 2. FIG. 2C is a cross sectional view of the structure of FIG. 2A.

In Preferred Embodiment 2, a coil antenna 31 is provided on the main surface of the antenna substrate 2, and a coil antenna 32 is provided on the back surface of the antenna substrate 2, which is different from Preferred Embodiment 1. The remaining structure and arrangement preferably are the same as those in Preferred Embodiment 1.

The coil antenna 31 and the coil antenna 32 are configured to have the antenna substrate 2 sandwiched therebetween, with a portion or all of the coil antennas 31 and 32 overlapping in the thickness direction. Furthermore, a winding direction of the loop of the coil antenna 31 preferably is opposite to that of the loop of the coil antenna 32. By using such structure, as shown in FIG. 2C, for the coil antenna 31 and the coil antenna 32, the capacitance is easily adjusted based on the distance and the overlapped area between the coil antennas 31 and 32 with the antenna substrate 2 disposed therebetween in the thickness direction. By adjusting the capacitance, the apparatus is designed to resonate near a signal frequency used for communication.

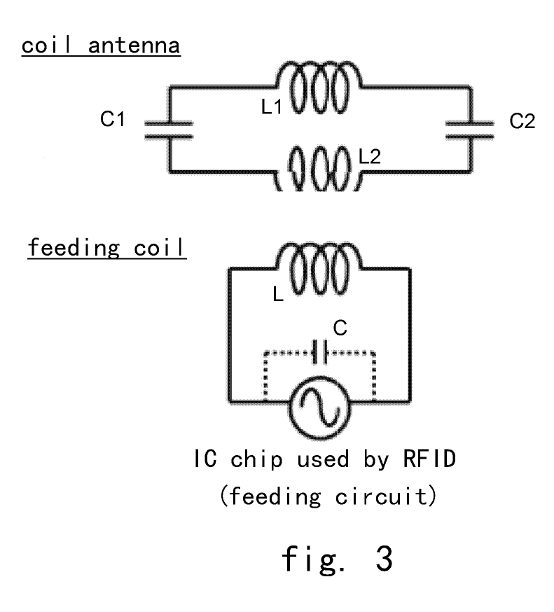

Specifically, the design may preferably be performed as follows. An equivalent circuit of the antenna apparatus in Preferred Embodiment 2 is shown in FIG. 3. A parallel resonating circuit is provided at the feeding side and includes a transceiver circuit and a feeding coil 4, and the parallel resonating circuit is defined by a stray capacitance C involved in an IC chip used by RFID and an inductance L involved in the coil pattern of the feeding coil 4. The resonating frequency of the resonating circuit is preferably set to approximate the carrier frequency (in the case of RFID, about 13.56 MHz, for example). Furthermore, a parallel resonating circuit is provided at the antenna side including the coil antenna 3, and the parallel resonating circuit is defined by a capacitor C1 and a capacitor C2 provided between the conductive pattern 31 and the conductive pattern 32. The resonating frequency of the resonating circuit is preferably set to approximate the carrier frequency (in the case of RFID, 13.56 MHz). Furthermore, the coil pattern of the feeding coil 4 is magnetically coupled with the conductive pattern 31 and conductive pattern 32, respectively. That is, the feeding coil 4 and the coil antenna 3 is magnetically coupled via a weak mutual inductance.

As described above, by using the overlapped area between the conductive patterns of the coil antennas 3 disposed on two main surfaces of the antenna substrate 2 to obtain the capacitance, a capacitance is obtained more easily than in Preferred Embodiment 1, and the electrode loss is significantly decreased or prevented. The result is that the performance of the antenna is greatly improved.

Because the coil antennas are preferably provided on two main surfaces of the antenna substrate, it is easy to provide a capacitance. Furthermore, compared with Preferred Embodiment 1, the number of windings (turns) of the conductive pattern is decreased. Thus, loss in the conductive pattern is suppressed as much as possible, and the performance of the antenna is significantly improved.

Preferred embodiments of the present invention are suitable for an antenna apparatus, and particularly, preferred embodiments of the present invention are suitable for an antenna apparatus for use in an RFID tag or reader-writer of a HF frequency band, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna apparatus, comprising:
an antenna substrate;
a coil antenna including a conductive pattern on the antenna substrate;
a feeding coil magnetically coupled with the coil antenna; and
a transceiver circuit electrically connected with the feeding coil; wherein
the feeding coil is disposed on a same substrate as the coil antenna, and is defined by a conductive pattern which is not electrically connected with the coil antenna;
two terminals of the feeding coil are electrically connected with the transceiver circuit.

2. The antenna apparatus according to claim 1, wherein the feeding coil is located at a more outer peripheral position than a location of the coil antenna.

3. The antenna apparatus according to claim 1, wherein the coil antenna is located on one main surface of the antenna substrate, and a capacitance is generated between adjacent conductive patterns of the coil antenna and the feeding coil.

4. The antenna apparatus according to claim 1, wherein the coil antenna is located on two main surfaces of the antenna substrate, and a capacitance is generated between the conductive patterns of the coil antenna and the feeding coil overlapped with the antenna substrate disposed therebetween.

5. The antenna apparatus according to claim 1, wherein the coil antenna and the feeding coil are located on a same plane of the antenna substrate.

6. The antenna apparatus according to claim 3, wherein the coil antenna and the feeding coil are located on a same plane of the antenna substrate.

7. The antenna apparatus according to claim 4, wherein the coil antenna and the feeding coil are located on a same plane of the antenna substrate.

8. The antenna apparatus according to claim 1, wherein the coil antenna includes a planar-shaped coil.

9. The antenna apparatus according to claim 1, wherein the conductive pattern of the coil antenna is ring-shaped.

10. The antenna apparatus according to claim 1, wherein the coil antenna includes at least two turns.

11. The antenna apparatus according to claim 1, wherein the feeding coil includes only one turn.

12. The antenna apparatus according to claim 1, further comprising electrode pads provided at the two terminals of the feeding coil to electrically connect the two terminals of the feeding coil with the transceiver circuit.

13. The antenna apparatus according to claim 1, further comprising another coil antenna.

14. The antenna apparatus according to claim 13, wherein the coil antenna is provided on one main surface of the antenna substrate and the another coil antenna is provided on another main surface of the antenna substrate.

15. The antenna apparatus according to claim 13, wherein a winding direction of the coil antenna is different from that of the another coil antenna.

16. An RFID system including the antenna apparatus according to claim 1.
